(19) United States
(12) Patent Application Publication
(10) Pub. No.: US 2009/0155016 A1
(43) Pub. Date: Jun. 18, 2009

(54) FASTENER FOR CONNECTING STRUCTURAL MEMBERS

(75) Inventor: SHI-KUN GUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO. LTD., Shenzhen City (CN); HON HAI PRECISION INDUSTRY CO., LTD., Tu-Cheng (TW)

(21) Appl. No.: 12/110,339

(22) Filed: Apr. 27, 2008

(30) Foreign Application Priority Data
Dec. 14, 2007 (CN) 200710203071.1

(51) Int. Cl. F16B 37/12; F16M 11/20

(52) U.S. Cl. 411/180; 248/188.1

(57) ABSTRACT

A fastener (10) for connecting two structural members includes a base (100) and a hollow protrusion (102) extending from the base. At least one supporting holder (160) extends from the base arranged around the protrusion. The supporting holder has a height above a top surface of the base equal to or greater than that of the protrusion.

### BACKGROUND

1. Field of the Invention

The present invention relates to fasteners, and particularly to a fastener for connecting structural members using a screw.

2. Description of Related Art

Conventional means for connecting structural members includes screws, clips, and adhesives. Screws are the most reliable and hence the most popular means for connecting structural members.

In general, most products are a combination of structural members that are connected to each other. If the structural members are made of plastic, it is easy to machine screw threads in the surfaces of the casing of each structural member and hence easy to connect the structural members together using screws. For example, the casing of a structural member, of a product, may be machined with a cylindrical protrusion with a hole. The cylindrical protrusion can then be used as a fastener to support a casing of an adjacent structural member. A thread is machined in the cylindrical protrusion for engaging with a screw of the adjacent casing so as to connect the two structural members together.

However, the plastic threads may strip or become damaged when a large force is used to tighten the screw. For enhancing the strength of the thread, a metallic nut, made of, for example, copper, having an internal thread is received in the hole of the plastic protrusion by means of hot press or hot melt by the following steps: heating the nut; pressing the heated nut into the hole of the plastic protrusion; and cooling the copper nut so that the nut is firmly embedded in the plastic protrusion. The plastic protrusion is also used to support the casing of an adjacent structural member so that the height of the plastic protrusion is determined according to an interval between the two adjacent casings of the structural members. Furthermore, other structural that may be between the two casing can be protected.

Moreover, precise assembly of two adjacent casings is achieved by machining the proper height of the plastic protrusion. However, during the process of pressing the heated nut into the plastic protrusion, the plastic protrusion may be distorted, possibly changing the height of the protrusion. Accordingly, the assembly precision, between the two adjacent casings, decreases.

What is needed, therefore, is a fastener, which can provide reliable support for the structural members for assembling two adjacent casings of structural members.

### SUMMARY

A fastener, for connecting two structural members, includes a base and a hollow protrusion extending from the base. At least one supporting holder extends from the base arranged around the protrusion. The height of the supporting holder above a top surface of the base is equal to or greater than that of the protrusion.

Other advantages and novel features of the present fastener will become more apparent from the following detailed description when taken in conjunction with the accompanying drawings.

### BRIEF DESCRIPTION OF THE DRAWINGS

Many aspects of the present fastener can be better understood with reference to the following drawings. The components in the drawings are not necessarily drawn to scale, the emphasis instead being placed upon clearly illustrating the principles of the present light source module. Moreover, in the drawings, like reference numerals designate corresponding parts throughout the several views.

FIG. 1 is a plan view of a fastener in accordance with an exemplary embodiment of the present invention.

FIG. 2 is a cross-sectional view of the fastener shown in FIG. 1.

FIG. 3 is a plan view of a cross section of a fastener in accordance with a second embodiment of the present invention.

FIG. 4 is a cross-sectional view of a fastener in accordance with a third embodiment of the present invention.

### DETAILED DESCRIPTION OF THE EMBODIMENTS

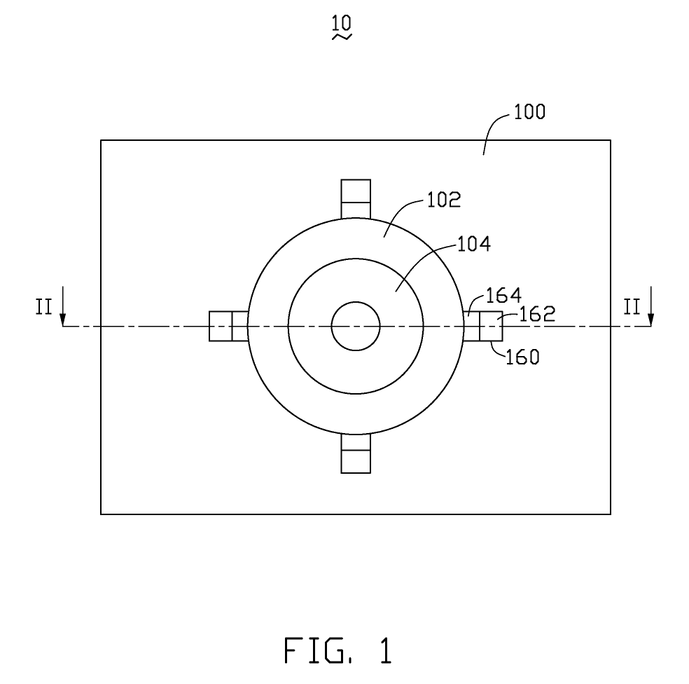

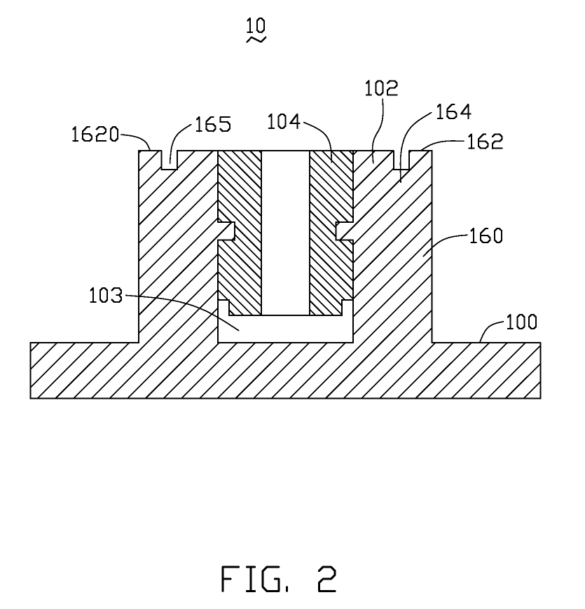

Referring to FIG. 1 and FIG. 2, a fastener 10 in accordance with one embodiment of the invention is shown. The fastener 10 is used to connect adjacent structural members (not shown) of a product. The fastener 10 comprises a base 100, a cylindrical protrusion 102, a nut 104 and four supporting holders 160.

The fastener 10 is made of plastic. The base 100 is a part of a casing of a structural member. Alternatively, the base 100 can be connected to the casing of the structural member by soldering. The cylindrical protrusion 102 extends up from the base 100. A blind hole 103 is defined in a middle of the cylindrical protrusion 102 for receiving the nut 104. The nut 104 can be made of metal, such as copper. The nut 104 can be pressed into the protrusion 102 by hot melt or hot press so as to firmly engage the nut 104 with the protrusion 102.

The four supporting holders 160 extend from the base 100, are evenly spaced around the protrusion 102, and are at a distance from the nut 104. Each of the supporting holders 160 has a supporting portion 162 and a connecting portion 164. The connecting portion 164 integrally connects the supporting portion 162 with an outer periphery of the protrusion 102 and is positioned between the protrusion 102 and the supporting portion 162. A top surface 1620 of the supporting portion 162 is used to support an adjacent structural member. The top surface 1620 is isolated from the protrusion 102 by a groove 165 defined in a top of the connecting portion 164. The supporting portion 162 has a height above a top surface of the base 100 determined according to an interval between the base 100 and the adjacent structural member in assembly. It is to be understood that the height of the supporting portion 162 can be equal to or greater than that of the protrusion 102 from the top surface of the base 100.

The supporting holders 160 are spaced apart from the nut 104 so that distortion of the protrusion 102 caused by the supporting holders 160 is minimized. The groove 165 can further minimize distortion of the supporting portion 162 of the supporting holders 160. Thus, the height of the supporting portion 162 does not change when the heated nut 104 is pressed into the hole 103. When a screw (not shown) is inserted into the nut 104 to connect the fastener 10 to the adjacent structural member, the supporting portions 162 of the supporting holders 160 provide better support to the adjacent structural member than the protrusion 102. Accordingly, the interval between the base 100 and the adjacent structural member can be kept precise. Furthermore, the supporting holders 160 can be used as a reinforced arm for the protrusion 102.

It is to be understood that the supporting holders 160 can be formed integrally with the base 100 or the protrusion 102. Also, the supporting holders 160 can be soldered to the base 100 or the protrusion 102. The number of the supporting holders 160 is not limited to four, but can be any number desired for providing uniform support for the adjacent structural member.

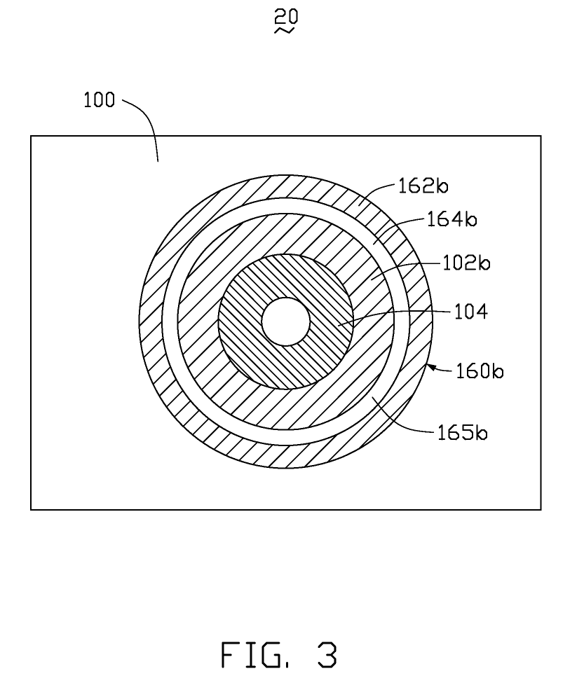

Referring to FIG. 3, a fastener 20 in accordance with a second embodiment of the present invention is shown. The fastener 20 has a base 100 and a supporting holder 160b extending upwardly from the base 100. The fastener 20 has a similar configuration to the fastener 10. The difference between the fastener 20 and the fastener 10 is that the supporting holder 160b is a circular, continuous body around a protrusion 102b. The supporting holder 160b has a connecting portion 164b and a supporting portion 162b. The connecting portion 164b integrally connects the supporting portion 162b with the protrusion 102b. A circular groove 165b is defined between the protrusion 102b and the supporting portion 162b. It is to be understood that the supporting portion 162b has a height above a top surface of the base 100 equal to or greater than that of the protrusion 102b. The bottom of the groove 165b is space from the base 100. It is to be understood that the supporting holder 160b can be soldered to the base 100 or the protrusion 102b. The supporting portion 162b continuous body can provide more supporting areas than the supporting portion 162 of the fastener 10.

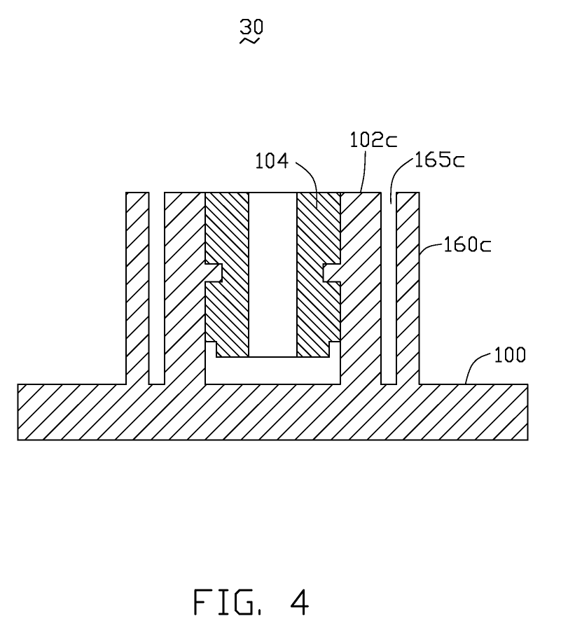

Referring to FIG. 4, a fastener 30 in accordance with a third embodiment of the present invention is shown. The fastener 30 has a supporting holder 160c around a protrusion 102c. The fastener 30 has a similar configuration to the fastener 20. The difference between the fastener 30 and the fastener 20 is that the supporting holder 160c of the fastener 30 is completely isolated from the protrusion 102c by a circular groove 165c. The supporting holder 160c extends from the base 100 and is spaced apart from the protrusion 102c. The groove 165c extends down to the base 100. It is to be understood that the supporting holder 160c has a height above a top surface of the base 100 equal to or greater than that of the protrusion 102c. The height is determined according to an interval between the base 100 and the adjacent structural member. It is to be understood, the supporting holder 160c can also be separately formed around the protrusion 102c. Also, the shape of the supporting holder 160c is not limited to a circular dimension, but can be triangular, square and so on.

It is believed that the embodiments and their advantages, of the present invention, will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A fastener comprising:
a base;
a hollow protrusion extending from the base;
at least one supporting holder extending from the base arranged around the protrusion, wherein
the at least one supporting holder has a height above a top surface of the base equal to or greater than that of the hollow protrusion.

2. The fastener as claimed in claim 1, wherein a groove is defined between the hollow protrusion and the at least one supporting holder.

3. The fastener as claimed in claim 2, wherein the at least one supporting holder comprises a connecting portion and a supporting portion, the connecting portion integrally connects the supporting portion with the protrusion, the groove is defined in a top surface of the connecting portion to partly isolate the supporting portion from the hollow protrusion, the supporting portion has a height, measured from a top surface of the base, that is equal to or greater than that of the hollow protrusion.

4. The fastener as claimed in claim 2, wherein the groove completely isolate the at least one supporting holder from the hollow protrusion.

5. The fastener as claimed in claim 1, wherein the at least one supporting holder is a continuous body formed around the hollow protrusion.

6. The fastener as claimed in claim 5, wherein the shape of the at least one supporting holder is chosen from a group consisting of circular, triangular, and square.

7. The fastener as claimed in claim 1, wherein more than one of the at least one supporting holder are evenly spaced around the hollow protrusion in a uniform order.

8. The fastener as claimed in claim 1, wherein the fastener further comprises a nut which is retained in the hollow protrusion.

9. The fastener as claimed in claim 8, wherein the nut is made of metal.

10. A structural member comprising:
a casing;
a hollow protrusion extending from the casing;
at least one supporting holder extending from the casing arranged around the protrusion, wherein
the supporting holder has a height above a top surface of the casing greater than or equal to that of the protrusion.

11. The structural member as claimed in claim 10, wherein a groove is defined between the protrusion and the at least one supporting holder.

12. The structural member as claimed in claim 11, wherein the at least one supporting holder comprises a connecting portion and a supporting portion, the connecting portion integrally connects the supporting portion with the protrusion, the groove is defined in a top surface of the connecting portion to partly isolate the supporting portion from the protrusion, the supporting portion has a height above a top surface of the casing equal to or greater than that of the protrusion.

13. The structural member as claimed in claim 11, wherein the groove completely isolate the at least one supporting holder from the protrusion.

14. The structural member as claimed in claim 10, wherein the at least one supporting holder is a continuous body formed around the protrusion.

15. The structural member as claimed in claim 14, wherein the shape of the at least one supporting holder is chosen from a group consisting of circular, triangular, and square.

16. The structural member as claimed in claim 10, wherein more than one supporting holders are evenly spaced around the protrusion.
